(19) United States
(12) Patent Application Publication
(10) Pub. No.: US 2026/0257559 A1
(43) Pub. Date: Sep. 3, 2026

(54) MICROMOBILITY DEVICE WITH INTEGRATED LIGHT ASSEMBLY

(71) Applicant: Also, Inc., Palo Alto, CA (US)

(72) Inventors: Patrick HARRINGTON, Asheville, NC (US); Adam Christopher BENDER, San Francisco, CA (US); Christopher YU, Menlo Park, CA (US); Robert Saul LEIKEN, San Francisco, CA (US)

(73) Assignee: Also, Inc., Palo Alto, CA (US)

(21) Appl. No.: 19/552,501

(22) Filed: Feb. 27, 2026

Related U.S. Application Data
(60) Provisional application No. 63/765,110, filed on Feb. 28, 2025.

(51) Int. Cl. B60L 1/16; B60L 50/20; B60L 50/60; B60Q 1/04; B60Q 1/26; F21S 41/151; F21S 41/19; F21S 41/25; F21S 41/663; F21S 43/14; F21S 43/15; F21S 43/19; F21V 23/00; F21W 103/20; F21Y 115/10

(52) U.S. Cl. CPC B60L 1/16; B60L 50/20; B60L 50/60; B60Q 1/0408; B60Q 1/2619; B60Q 1/2696; F21S 41/151; F21S 41/192; F21S 41/25; F21S 41/663; F21S 43/14; F21S 43/15; F21S 43/19; F21V 23/004; B60L 2200/12; B60L 2250/16; F21W 2103/20; F21Y 2115/10

(57) ABSTRACT

A micromobility device can include a frame having a control device, a head tube, and a top tube. The micromobility device can include a first wheel and a second wheel rotatably coupled with the frame. The bike can include a front light assembly integrally coupled with the head tube and a rear light assembly integrally coupled with the top tube. The bike can include the control device to control an operation of the drive mechanism, the front light assembly, and the rear light assembly. The control device can transmit a first signal to cause the front light assembly to emit light at a first state of a first plurality of states in which the front light assembly emits light, and a second signal to cause the rear light assembly to emit light at a second state of a second plurality of states in which the rear light assembly emits light.

### CROSS-REFERENCE TO RELATED APPLICATION

This U.S. Patent Application claims the benefit and priority to U.S. Provisional Application No. 63/765,110, filed February 28, 2025, the entire disclosures of which is hereby incorporated by reference herein.

### BACKGROUND

Bicycles can include an electric motor that receives power from a battery.

### SUMMARY

One aspect is directed to a micromobility device. The micromobility device can include a frame. The frame includes a head tube and a top tube. The micromobility device can include a first wheel and a second wheel rotatably coupled with the frame. The micromobility device can include a drive mechanism coupled with the frame and configured to rotate at least one of the first wheel and the second wheel. The micromobility device can include a battery coupled with the frame and operatively coupled with the drive mechanism. The battery can cause the drive mechanism to rotate the at least one of the first wheel and the second wheel. The micromobility device can include a front light assembly integrally coupled with the head tube and including a first control printed circuit board assembly (PCBA). The micromobility device can include a rear light assembly integrally coupled with the top tube and including a second control PCBA. The micromobility device can include a control device coupled with the frame. The control device can transmit a first signal to the first control PCBA to cause the front light assembly to emit light at a first state of a first plurality of states in which the front light assembly emits light. The control device can transmit a second signal to the second control PCBA to cause the rear light assembly to emit light at a second state of a second plurality of states in which the rear light assembly emits light. The control device can control an operation of the drive mechanism.

Another aspect is directed to a bike. The bike can include a frame including a head tube and a top tube. The bike can include a first wheel and a second wheel rotatably coupled with the frame. The bike can include a drive mechanism coupled with the frame and configured to rotate at least one of the first wheel and the second wheel. The bike can include a control device coupled with the frame and configured to receive and to transmit control signals. The bike can include a front light assembly integrally coupled with the head tube. The front light assembly can include a first printed circuit board assembly (PCBA), a first light element, a second light element, and a third light element. The PCBA can be communicably coupled with the control device. The PCBA can receive a signal from the control device to cause the first light element to emit light at a first state of a plurality of different states, cause the second light element to emit light at a second state of a plurality of different states, and cause the third light element to emit light at a third state of a plurality of different states. Each of the first state, the second state, and the third state can be different. The bike can include a rear light assembly integrally coupled with the top tube. The rear light assembly can include a plurality of light elements communicably coupled with the control device. The control device can cause at least one of the plurality of light elements to emit light at a fourth state of a plurality of different states.

Another aspect is directed to a method. The method can include rotatably coupling a first wheel of a bike and a second wheel of the bike with a frame of the bike. The frame can include a control device, a head tube, and a top tube. The method can include coupling a drive mechanism with the frame to rotate at least one of the first wheel and the second wheel. The method can include coupling a battery with the frame. The battery can be operatively coupled with the drive mechanism. The battery can cause the drive mechanism to rotate the at least one of the first wheel and the second wheel. The method can include integrally coupling a front light assembly including a first control PCBA with the head tube. The method can include integrally coupling a rear light assembly including a second PCBA with the top tube. The method can include transmitting, by the control device, a first signal to the first control PCBA to cause the front light assembly to emit light at a first state of a first plurality of states in which the front light assembly emits light. The method can include transmitting, by the control device, a second signal to the second control PCBA to cause the rear light assembly to emit light at a second state of a second plurality of states in which the rear light assembly emits light. The method can include controlling, by the control device, an operation of the drive mechanism.

One aspect is directed to a method. The method can include providing a micromobility device. The micromobility device can include a frame. The frame includes a head tube and a top tube. The micromobility device can include a first wheel and a second wheel rotatably coupled with the frame. The micromobility device can include a drive mechanism coupled with the frame and configured to rotate at least one of the first wheel and the second wheel. The micromobility device can include a battery coupled with the frame and operatively coupled with the drive mechanism. The battery can cause the drive mechanism to rotate the at least one of the first wheel and the second wheel. The micromobility device can include a front light assembly integrally coupled with the head tube and including a first control printed circuit board assembly (PCBA). The micromobility device can include a rear light assembly integrally coupled with the top tube and including a second control PCBA. The micromobility device can include a control device coupled with the frame. The control device can transmit a first signal to the first control PCBA to cause the front light assembly to emit light at a first state of a first plurality of states in which the front light assembly emits light. The control device can transmit a second signal to the second control PCBA to cause the rear light assembly to emit light at a second state of a second plurality of states in which the rear light assembly emits light. The control device can control an operation of the drive mechanism.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification. The foregoing information and the following detailed description and drawings include illustrative examples and should not be considered as limiting.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts an example bicycle, in accordance with some aspects.

FIG. 2 depicts an example light assembly for a bicycle, in accordance with some aspects.

FIG. 3 is a cross-sectional view of an example light assembly for a bicycle, in accordance with some aspects.

FIG. 4 is a cross-sectional view of an example light assembly for a bicycle, in accordance with some aspects.

FIG. 5 is a cross-sectional view of an example light assembly for a bicycle, in accordance with some aspects.

FIG. 6 depicts an example light assembly for a bicycle, in accordance with some aspects.

FIG. 7 depicts an example light assembly for a bicycle, in accordance with some aspects.

FIG. 8 depicts an example bicycle, in accordance with some aspects.

FIG. 9 depicts an example bicycle, in accordance with some aspects.

FIG. 10 depicts an example bicycle, in accordance with some aspects.

FIG. 11 depicts an example bicycle, in accordance with some aspects.

FIG. 12 depicts an example bicycle, in accordance with some aspects.

FIG. 13 depicts an example bicycle, in accordance with some aspects.

FIG. 14 is a block diagram illustrating an architecture for a computer system that can be employed to implement elements of the systems and methods described and illustrated herein, including, for example, the light assemblies of FIGS. 1–13.

FIG. 15 is a flow diagram of an example method of assembling and operating a bicycle, in accordance with some aspects.

FIG. 16 is a flow diagram of an example method of providing a bicycle, in accordance with some aspects.

### DETAILED DESCRIPTION

Following below are more detailed descriptions of various concepts related to, and implementations of, methods, apparatuses, and systems of integrating feedback systems into bicycles. The various concepts introduced above and discussed in greater detail below may be implemented in any of numerous ways.

The technical solutions are generally directed to a micromobility device, such as a bicycle, having at least one integrated light assembly. For example, the bike can include a central control device that can control or otherwise influence the operation of the integrated light assembly. The integrated light assembly can be coupled with a frame of the bike, rather than being a separate detachable accessory. For example, the bike can include a first light assembly (e.g., a front light assembly) that is coupled with a head tube of the bike and is configured to operate based on a signal received from the control device that can be positioned within the frame of the bike. The control device can be positioned on an exterior of the frame of the bike. The control device can be a remote control device, such as a mobile phone. The bike can include a second light assembly (e.g., a rear light assembly) that is coupled with the top tube of the bike and is configured to operate based on a signal from the control device. The first light assembly in the second light assembly can be integral with the bike.

The control device of the bike can control or influence an operation of the first light assembly in the second light assembly based on a user input (e.g., user input received via a user input device) or based on a status or parameter of the bike or some component thereof. For example, the control device can control operation of the first light assembly. The second light assembly can indicate a state of charge of a battery of the bike or a status of a charging operation of the battery. In examples, the control device can cause the first light assembly or the second light assembly to illuminate in a particular fashion (e.g., according to some sequence or in a particular color) in response to a proximity of the user to the bike (e.g., a welcome or goodbye animation). The bike can include the rear light assembly having a curvature corresponding to a curvature of the top tube of the bike, such that the rear light assembly can illuminate at least partially to a first side and the second side of the bike. By illuminating the first side or second side of the bike, the rear light assembly can illuminate a portion of the user (e.g., the user’s limb) during the operation of the bike where the illumination of a portion of the user can illuminate human motion to bystanders. Technically and beneficially, the control device of the bike can be communicatively coupled with control devices of other bikes, such as other bikes in a caravan of bikes riding together. The control device associated with a lead bike can transmit control signals to control devices of other bikes within a caravan. These control signals cause the light assemblies of the caravan bikes to illuminate according in a particular fashion. For example, when the control device of the lead bike activates its light assembly to function as a turn signal, it can transmit a corresponding control signal to the control devices of the other bikes in the caravan, thereby causing their respective lighting assemblies to function as a turn signal.

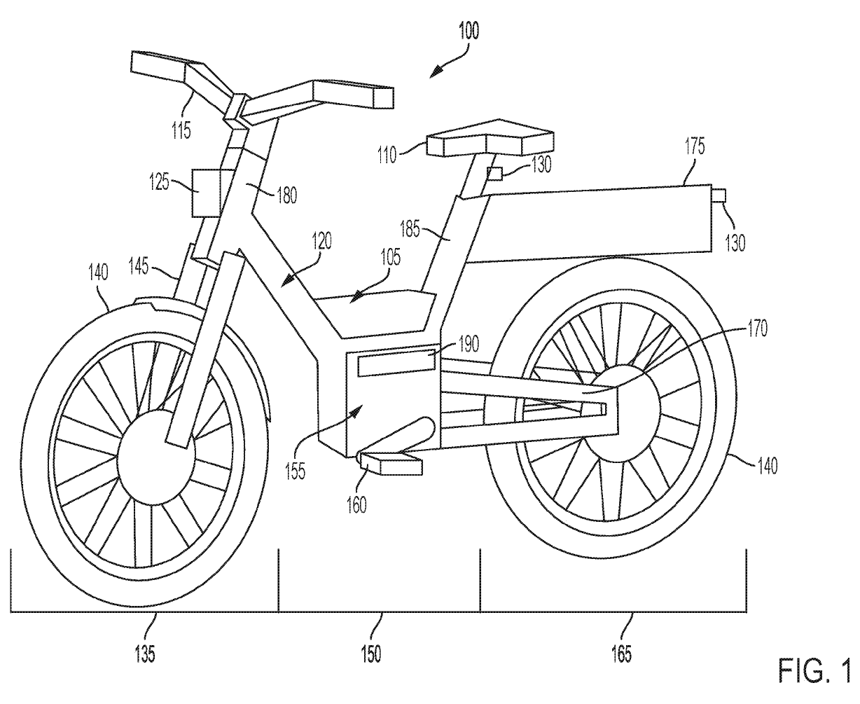

FIG. 1 depicts an example perspective view of a micromobility device 100. The micromobility device 100 can be an electric bike (referred to herein as bike 100, bicycle 100, and similar variations thereof) installed with at least one battery 105. The bicycle 100 can be a human-operated bike 100. The micromobility device 100 can include single rider bicycles, tandem bicycles, cargo bicycles, motor-assist bicycles, pedicabs, electric-assist bicycles, ebikes, road bicycles, mountain bicycles, unicycles, segways, or scooters, among others. The battery 105 can also be used as an energy storage system to power a building, such as a residential home or commercial building.

The bike 100 can be fully electric or partially electric (e.g., pedal-powered) and further, the electric bike 100 can be fully autonomous, partially autonomous, semi-autonomous, or unmanned. The electric bike 100 can also be human operated or non-autonomous. A human operator or the rider of the bike 100 can sit on a saddle 110 to operate the bike 100. The rider of the bike 100 can steer, grip, balance, or otherwise control the bike 100 using the handlebar 115.

The bike 100 can include a frame 120. The frame 120 can support various components of the bike 100, such as a handlebar 115, the saddle 110, the battery 105, at least one front light assembly 125, and at least one rear light assembly 130. The frame 120 can span a front portion 135. The front portion 135 can support, be coupled with, or include, for example, a wheel 140 of the bike 100, a fork 145 of the bike 100, a head tube 180 of the bike 100, the handlebar 115, the front light assembly 125, among other components. The bike 100 can include two or more wheels 140 (e.g., a front wheel 140 and a rear wheel 140). The frame 120 can span a middle portion 150 (e.g., a central portion). The middle portion 150 can support, be coupled with, or include, for example, the saddle 110, the battery 105, a crank shaft or drive mechanism 155 of the bike 100, or a pedal 160 of the bike 100, a top tube 185, among other components. The drive mechanism 155 can be an electrical motor or some other electrical propulsion mechanism that can create some motion (e.g., rotation of some shaft) in response to an electrical signal (e.g., from a control device 190). The frame 120 can include the middle portion 150. The middle portion 150 can include the rear light assembly 130. The frame 120 can include a rear portion 165. The rear portion 165 can support, be coupled with, or include, for example, a rear wheel 140 of the bike 100, the rear light assembly 130, a drivetrain 170 of the bike 100, or a rear member 175 of the bike 100, among other components. The drivetrain 170 of the bike 100 can be a chain, gear, belt, or some combination thereof that couples the drive mechanism 155 with the rear wheel 140 of the bike 100 such that the drive mechanism 155 can rotate or drive the rear wheel 140. The rear member 175 of the bike 100 can be a rear fender, a rack configured to stow or support luggage or some other object, a child seat, a pet carrier, a basket, or some other object. The battery 105 can be disposed anywhere within the frame 120.

The bike 100 can include at least one battery 105 or battery pack 105 that can be or include at least one battery 105, at least one battery module, or at least one battery cell. The battery 105 can be electrically coupled with the bike 100 (e.g., to the drive mechanism 155, to the front light assembly 125, the rear light assembly 130, or some other component(s)). For example, the battery 105 can provide electrical energy to the bike 100 to power the bike 100. For example, the battery 105 can provide electrical energy to the drive mechanism 155 to cause the drive mechanism 155 to operate (e.g., to rotate the wheel 140 of the bike 100). The battery 105 can be installed or placed within the bike 100. For example, the battery 105 can be installed on the frame 120 of the bike 100 within one or more of the front portion 135, the middle portion 150, or the rear portion 165. The battery 105 can be integrally coupled with the frame 120 such that it is not removable. The battery 105 can be detachably coupled with the frame 120 such that in can be removed (e.g., to charge the battery 105). The battery 105 can include or connect with at least one busbar, e.g., a current collector element. For example, the busbar can include electrically conductive material to connect or otherwise electrically couple the battery 105 with other electrical components of the bike 100 to provide electrical power to various systems or components of the bike 100, such as the front light assembly 125, the rear light assembly 130, or some other system.

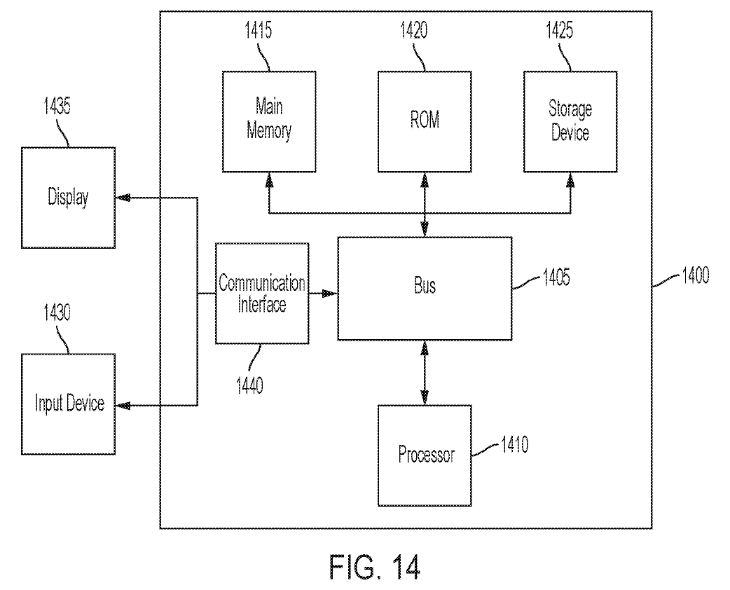

The bike 100 can include a control device 190. The control device 190 can be a computing system 1400 (as depicted in detail in FIG. 14, among others), a printed circuit board assembly (PCBA) 190, a CAN control device 190, a microcontroller 190, a combination of such control devices, or some other control device that can be configured to control operation of the bike 100 or various components of the bike 100 (e.g., the front light assembly 125, the rear light assembly 130, the drive mechanism 155, or otherwise). The control device 190 can be electrically or communicatively coupled with the front light assembly 125 or the rear light assembly 130. For example, the front light assembly 125 can receive a control signal (e.g., a CAN communication) from the control device 190, where the control signal can cause or influence (e.g., change, initiate, cease) an operation of the front light assembly 125. The rear light assembly 130 can receive a control signal (e.g., a CAN communication) from the control device 190, where the control signal can cause or influence (e.g., change, initiate, cease) an operation of the rear light assembly 130. The drive mechanism 155 can receive a control signal (e.g., a CAN communication) from the control device 190, where the control signal can cause or influence (e.g., change, initiate, cease) an operation of the drive mechanism 155.

The bike 100 can include front light assembly 125 and the rear light assembly 130 electrically coupled with the battery 105. For example, the battery 105 can be electrically coupled with the front light assembly 125 or the rear light assembly 130 to facilitate the operation (e.g., the illumination of) the front light assembly 125 or the rear light assembly 130. The bike 100 can include the control device 190 electrically coupled with the battery 105. For example, the battery 105 can be electrically coupled with the control device 190 to facilitate the operation of (e.g., to power) the control device 190 such that the control device 190 can receive electrical or control signals (e.g., a signal responsive to a user input), provide electrical or control signals (e.g., a signal to control one or more of the front light assembly 125, the rear light assembly 130, or some other component), or to perform one or more control operations (e.g., determine what control signal to transmit to the front light assembly 125 or the rear light assembly 130 in response to some other information, such as sensor data or otherwise). In this way, the front light assembly 125, the rear light assembly 130, and the control device 190 can be configured to be controlled or actuated electronically via power provided by the battery 105, rather than being controlled by some external power source (e.g., an external or separate battery). For example, the battery 105 can provide power to the drive mechanism 155 to power the bike 100 (e.g., propel the bike 100 by causing the at least one wheel 140 to rotate) and also provide power to the front light assembly 125, the rear light assembly 130, and the control device 190. The battery 105 can provide power to the front light assembly 125, the rear light assembly 130, and the control device 190 and other components of the bike 100 (e.g., the drive mechanism 155, the front light assembly 125, or some other component) simultaneously, separately, in sequence, or in some other manner.

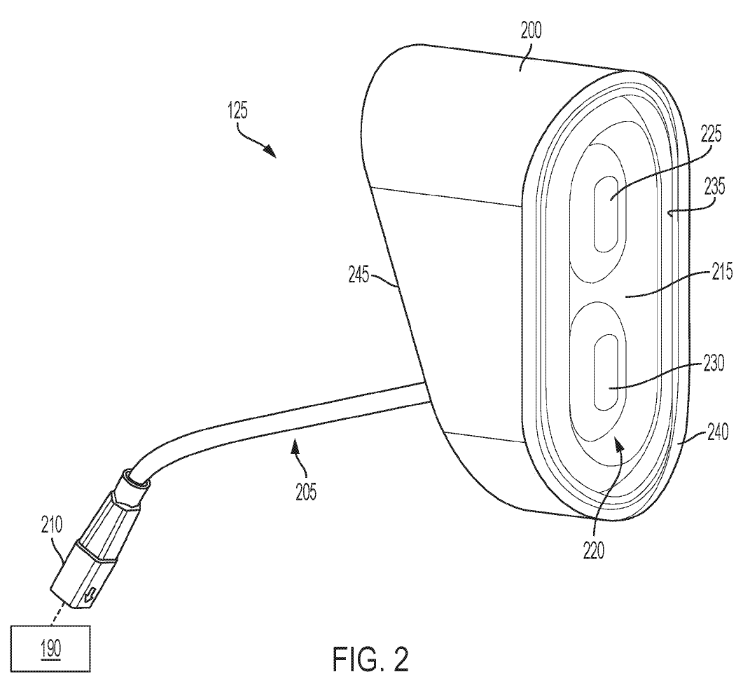

As depicted in FIGS. 2–5, among others, the front light assembly 125 can include a first lighting device 225, shown as a first projector 225, a second lighting device 230, shown as a second projector 230, and a third lighting device 235, shown as a light ring 235. The front light assembly 125 can include each of the first projector 225, the second projector 230, and the light ring 235 positioned within a housing 200. The housing 200 defines a cavity 220 and a back surface 245. The front light assembly 125 includes a bezel 215 positioned within the cavity 220. The first projector 225, the second projector 230, and the light ring 235 are positioned within the cavity 220 and can emit light from within the cavity 220 to emit light through a lens cover 240 of the front light assembly 125. For example, the first projector 225 and the second projector 230 can be coupled to and supported by the bezel 215 within the cavity 220 with the first projector 225 and the second projector 230 directed toward the lens cover 240 of the housing 200 such that the first projector 225 and the second projector 230 emit light at least partially through the housing 200. The light ring 235 can be positioned radially around a periphery of the cavity 220 and proximate an inner edge or surface of the housing 200. For example, the light ring 235 can be positioned around a perimeter of the bezel 215 and thus around the first projector 225 and the second projector 230. The light ring 235 can be coupled to the bezel 215 in some examples. The first projector 225 and the second projector 230 can be positioned within a perimeter of the light ring 235.

The front light assembly 125 includes a harness 205 that couples the front light assembly 125 with the control device 190 of the bike 100. For example, the harness 205 can include a first end 340 and a second end 210. The second end 210 is communicable and electrically coupled to the control device 190. For example, the harness 205 can receive an electrical signal and or a control signal from the control device 190 to provide the electrical signal or the control signal to the front light assembly 125. The electrical signal can power the front light assembly 125. For example, the electrical signal can include a 12-volt signal that provides power to the front light assembly 125. The control signal can be or include a CAN signal where the signal can be configured to control, influence or modify an operation of the front light assembly 125, as noted above. For example, the control device 190 can cause the front light assembly 125 to emit light at a state from a plurality of states. The plurality of states can include an unlit state and various states in which the front light assembly 125 emits light.

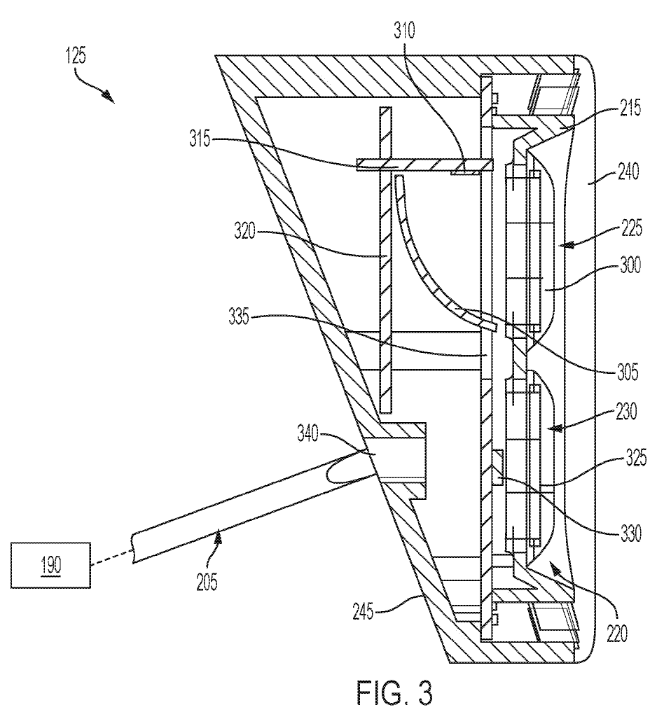

As depicted in FIG. 3, among others, the front light assembly 125 can include a control device 190, shown as first control PCBA 320. The first projector 225 can include a first lens 300, a first light element 310, a first control device 315 (shown as a first PCBA 315), and a mirror 305. The first PCBA 315 can provide an electrical or a control signal to the first light element 310. For example, the first PCBA 315 can provide an electrical signal and a control signal to cause the first light element 310 to emit light. The first PCBA 315 can further control, influence, or otherwise modify the operational state of the first light element 310. For example, the first PCBA 315 can provide a control signal to the first light element 310 to cause the first light element 310 to emit light of a certain temperature, color, intensity, or other characteristic. The first PCBA 315 can be communicatively and electrically coupled to the first control PCBA 320. For example, the first control PCBA 320 can provide an electrical or a control signal to the first PCBA 315. For example, in a first state, the first PCBA 315 or the first control PCBA 320 can cause the first light element 310 to emit a first light intensity. In a second state, the first PCBA 315 or the first control PCBA 320 can cause the first light element 310 to emit a second light intensity different from the first light intensity. In this way, the first light element 310 can emit light at a plurality of operational states in which the second light element 330 emits light.

The first light element 310 can emit light in a direction at least partially towards at least a portion of the mirror 305. For example, the first light element 310 can emit light towards the mirror 305 where said emitted light is reflected at least partially by the mirror 305. As depicted in FIG. 3, among others, the first light element 310 can be coupled to the first PCBA 315 and positioned at least partially above at least a portion of the mirror 305. As shown, the mirror 305 includes a curved or arcuate shape that slopes in a generally downward direction from the first PCBA 315 toward an inner surface of the first lens 300. In other examples, the mirror 305 can have or exhibit some other shape or form factor. In the example shown in FIG. 3, the first PCBA 315 is oriented in a generally horizontal orientation such that the first light element 310 emits light in a generally downward direction toward the mirror 305. The curved or arcuate shape of the mirror 305 can cause the light emitted by the first light element 310, which is emitted in a generally downward direction, to be reflected, diffused, refracted, or otherwise modified to be directed in a partially horizontal direction. For example, the light emitted by the first light element 310 can be reflected by the mirror 305 and directed through the first lens 300 of the first projector 225. In this way, the light emitted by the first light element 310 can be reflected, diffused, refracted, or otherwise modified in order to comply with relevant regulations.

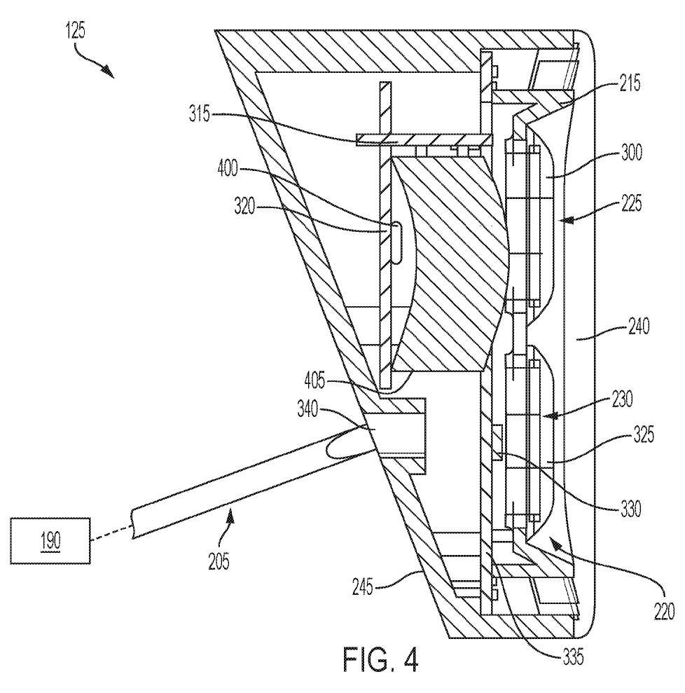

Although the first light element 310 is shown as being configured to emit light in a downward direction towards a mirror 305 and the mirror 305 redirects the light in a horizontal direction through the first lens 300, it is understood that other positions of the first light element 310 with respect to the mirror 305 and the first lens 300 of the first projector 225 are possible to achieve the same effect. For example, as shown in FIG. 4, among others, the first projector 225 can include the first light element 310 positioned behind a light modifying element 405 such that the first light element 310 can emit light towards and through the first light modifying element 405 or the first light modifying element 405 can modify said emitted light for further directing the emitted light through the first lens 300 of the first projector 225. The light modifying element 405 and the first light element 310 can both be positioned horizontally adjacent to the first lens 300 of the first projector 225 such that the light emitted by the first light element 310 is generally directed towards the first lens 300 of the first projector 225. In this way, the first light modifying element 405 need not redirect light in a manner similar to that described above with respect to FIG. 3 for the light emitted by the first light element 310 to be emitted through the first lens 300. The first light element 310 can be at least one light emitting diode (LED) that can emit light in response to electrical or control signal of a varying intensity, temperature, or wavelength. For example, the first light element 310 can be or include an RGB LED that can selectively emit light in various colors in response to a signal. In some examples the first light element 310 can be or include an array of multiple LEDs, each of which can be controlled individually or in concert with other LEDs of the first light element 310.

The front light assembly 125 can include the second projector 230 having a second lens 325, a second control device 335, and a second light element 330. The second control device 335 can be a second PCBA 335. The second light element 330 can be electrically and communicatively coupled to the second PCBA 335. For example, the second PCBA 335 can provide an electrical signal to power the second light element 330 in order to cause the second light element 330 to emit light. The second PCBA 335 can further control, influence, or otherwise modify an operation of the second light element 330. For example, the second PCBA 335 can provide a control signal to the second light element 330 to cause the second light element 330 to emit light of a certain temperature, intensity, or other characteristic. As shown in FIGS. 3–5, among others, the second projector 230 can include the second light element 330 positioned behind the second lens 325 such that the second light element 330 emits light directly through the second lens 325 without first being reflected, diffused, refracted, or otherwise manipulated by a mirror or other element for example. The second light element 330 can be at least one LED that can emit light in response to electrical or control signal of a varying intensity, temperature, or wavelength. For example, the second light element 330 can be or include an RGB LED that can selectively emit light in various colors in response to a signal. In some examples the second light element 330 can be or include an array of multiple LEDs, each of which can be controlled individually or in concert with other LEDs of the second light element 330.

The bike 100 can include the first projector 225 to emit light according to European specific requirements or regulations. For example, the first projector 225 can include the first light element 310 emitting light through the first lens 300 after first reflecting off of the mirror 305 so that light emitted by the first light element 310 can be shaped to meet a narrow field of view having a cutoff where the emitted light and the shape thereof to comply with relevant regulations. The shape of the field of view for the first projector 225 can be varied according to various standards or according to the user’s preference. For example, the first projector 225 can function as a fog light, where the emitted light is directed downward toward a ground surface with a wide field of view. The second projector 230 can emit light according to some other standard or regulation. For example, the second projector 230 can conform to standards of some other jurisdiction, such as the United States or otherwise. The second light element 330 can emit light through the second lens 325 of the second projector 230 so as to create a bright, highly illuminating, wide field of view. For example, the second projector 230 can provide a bright light to function in a high beam mode. In other examples, the second projector 230 could emit light to perform a fog light function, or some other function, according to some regulation, a user’s preference, or otherwise. As discussed below each of the first light element 310 and the second light element 330 can be controlled, adjusted, manipulated, or otherwise influenced by the first PCBA 315, the second PCBA 335, the first control PCBA 320, or the control device 190, as the case may be, which can permit each of the first projector 225 and the second projector 230 to emit light at any number of states in which the first projector 225 and the second projector 230 emit light.

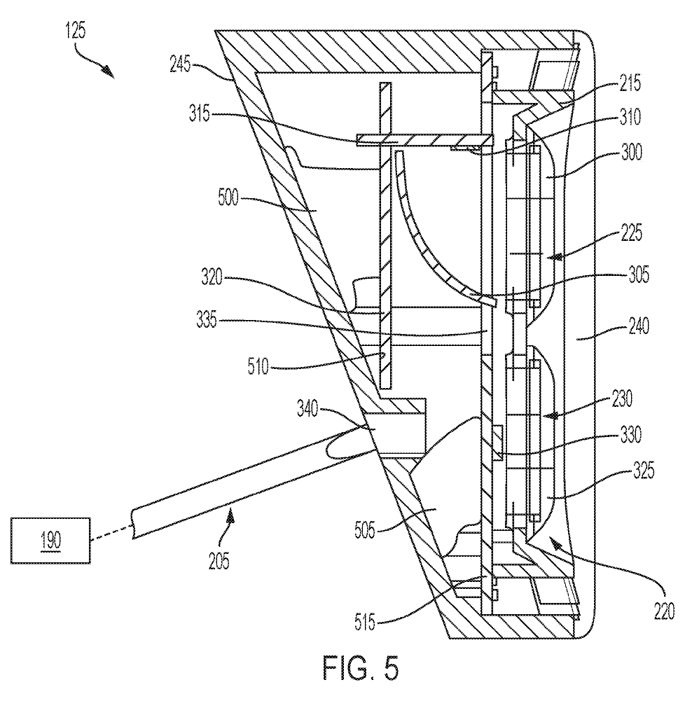

As shown in FIG. 5, among others, the front light assembly 125 can include a first support 500 and a second support 505. The first support 500 can be coupled with the housing 200 and can extend forward from the back surface 245 of the housing 200 in a direction toward the first lens 300 of the first projector 225. The first support 500 can be or include a thermally conductive material that can draw heat energy away from the first control PCBA 320. For example, the first support 500 can be positioned against or approximate to a surface 510 of the first control PCBA 320 to reduce a temperature of at least a portion of the first control PCBA 320, so as to ensure proper operation and performance of the first control PCBA 320, and thus proper operation and performance of the front light assembly 125. The first support 500 can further provide structural support to the first control PCBA 320. For example, the first support 500 can be coupled with the housing 200 and the surface 510 of the first control PCBA 320. The first support 500 can act to provide structural rigidity to the first control PCBA 320 such that the structural integrity of the first control PCBA 320 is not compromised during operation of the bike 100. The second support 505 can be coupled with the housing 200 and can extend forward from the back surface 245 of the housing 200 in the direction toward the second lens 325 of the second projector 230. The second support 505 can be or include a thermally conductive material that can draw heat energy away from the second PCBA 335. For example, the second support 505 can be repositioned against or approximate to surface 515 of the second PCBA 335 to reduce a temperature at least a portion of the second PCBA 335, so as to ensure proper operation and performance of the second PCBA 335, and thus proper operation performance of the front light assembly 125. The second support 505 can further provide structural support to the second PCBA 335. For example, the second support 505 can be coupled with the housing 200 and the surface 515 of the second PCBA 335.

As noted above, the control device 190 can be a PCBA 190, the control device 320 can be a first control PCBA 320, the first control device 315 can be a first PCBA 315, and the second control device 335 can be a second PCBA 335. In other examples, the control device 190, the control device 320, the first control device 315, or the second control device 335 can each be a printed circuit board, a controller, a computing system, or some other device configured to control some operation of the front light assembly 125. The first PCBA 315 can be communicably coupled with the first light element 310. For example, the first PCBA 315 can be communicably coupled with the first light element 310 to cause the first light element 310 to emit light in a particular fashion, such as with a particular light temperature, a particular light intensity, at a particular wavelength, for a certain duration, at particular intervals, or according to some other characteristic. For example, the second PCBA 335 can be communicably coupled with the second light element 330 to cause the second light element 330 to emit light in a particular fashion, such as with a particular light temperature, a particular light intensity, at a particular wavelength, for a certain duration, at particular intervals, or according to some other characteristic.

The control device 190 and the first control PCBA 320 can be electrically coupled with the battery 105. The first control PCBA 320 of the front light assembly 125 can be coupled with the control device 190. The first control PCBA 320 can be further electrically and communicably coupled with the first PCBA 315 and the second PCBA 335. For example, the control device 190, the first control PCBA 320, the first PCBA 315, and the second PCBA 335 can use electrical power to function. The first control PCBA 320 can receive power from the battery 105, whether directly from the battery 105 or indirectly such as via the control device 190, and provide electrical energy to the first PCBA 315 and the second PCBA 335, each of which can respectively provide power to the first light element 310 and the second light element 330. For example, the battery 105 can provide power to the first control PCBA 320, the first control PCBA 320 can provide power to the first PCBA 315, and the first PCBA 315 can in turn provide power to the first light element 310. Likewise, the battery 105 can provide power to the first control PCBA 320, the first control PCBA 320 can provide power to the second PCBA 335, and the second PCBA 335 can in turn provide power to the second light element 330. The first PCBA 315 or the first control PCBA 320 can control or modulate a polarity of a voltage provided to the first light element 310 to influence the operation of the first light element 310. The second PCBA 335 or the first control PCBA 320 can control or modulate a polarity of a voltage provided to the second light element 330 to influence the operation of the second light element 330. For example, the second PCBA 335 or the first control PCBA 320 can control or modulate a polarity of voltage provided to the second light element 330 to change an operational state of the second light element 330. For example, in a first state, the second PCBA 335 or the first control PCBA 320 can cause the second light element 330 to emit a first light intensity. In a second state, the second PCBA 335 or the first control PCBA 320 can cause the second light element 330 to emit a second light intensity different from the first light intensity. In this way, the second light element 330 can emit light at a plurality of operational states in which the second light element 330 emits light.

Each of the control device 190, the first control PCBA 320, the first PCBA 315, and the second PCBA 335 can include a communication interface to facilitate communications with one or more other components. The communication interface can permit other devices (e.g., a control device 190) to communicate with the associated PCBA (e.g., the first control PCBA 320) for the purpose of controlling the PCBA and ultimately controlling the device or devices coupled with the PCBA. For example, the communication interface of the first control PCBA 320 can permit the control device 190 to communicate with the first control PCBA 320 for the purpose of controlling one or more of the first PCBA 315 and the second PCBA 335 via the first control PCBA 320. In another example, the communication interface of the first PCBA 315 can permit the first control PCBA 320 to communicate with the first PCBA 315 for the purpose of causing the first PCBA 315 to control the first light element 310, monitor the operation of the first PCBA 315 or the first light element 310, or otherwise communicating with the first light element 310. Each of the first control PCBA 320, first PCBA 315, and the second PCBA 335.

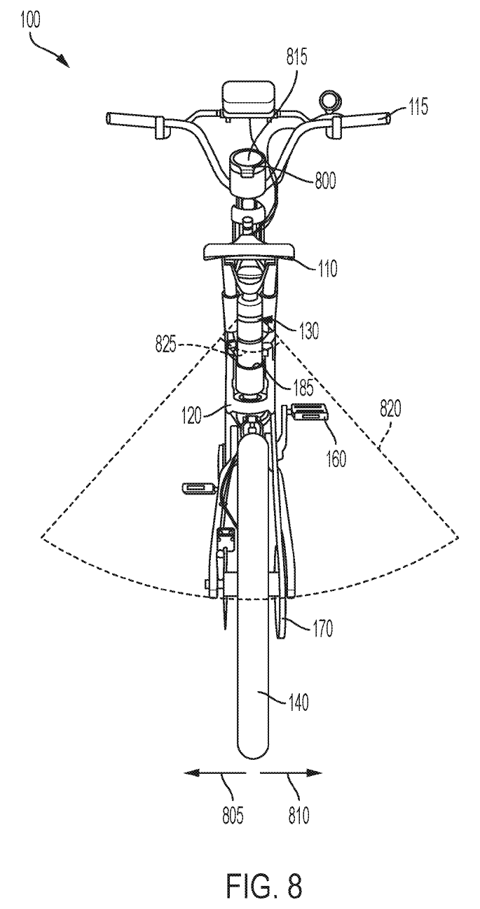

Each of the control device 190, the first control PCBA 320, the first PCBA 315, and the second PCBA 335 can include the communication interface to communicate with other components of the bike 100, such as the user input device 800 (as shown in FIG. 8, among others, and discussed below), or with an operator, or other device. For example, the first control PCBA 320 can include the communication interface to receive data regarding the battery 105 (e.g., a state of charge or some other property of the battery 105), to receive a control signal from the control device 190, to transmit data to the control device 190 (e.g., data regarding the operation or status of the first light element 310 or the first projector 225). The communication interface of each of the control device 190, the first control PCBA 320, the first PCBA 315, and the second PCBA 335 can be configured for wireless communication (e.g., radio frequency transmissions, short-range wireless transmissions, near field communication (NFC) transmissions, or other wireless communications). For example, the first control PCBA 320 can include an input/output device (e.g., a wireless transceiver or some other device) to facilitate wireless communications or wired communication between the first control PCBA 320 and some other device (e.g., an operator’s mobile device, some other network-connected device). The communication interface of each of the control device 190, the first control PCBA 320, the first PCBA 315, and the second PCBA 335 can facilitate communication with remotely located devices, such as a central operator (e.g., the manufacturer of the bike 100 or some other trusted entity), another bike 100 operated by another user, or otherwise. For example, each of the control device 190, the first control PCBA 320, the first PCBA 315, and the second PCBA 335 can receive over the air (OTA) updates via the communication interface.

The communication interface of each of the control device 190, the first control PCBA 320, the first PCBA 315, and the second PCBA 335 can communicate with other bikes 100, such as other bikes 100 within a caravan or fleet. For example, the control device 190 of a first bike 100 can be communicatively coupled with a control device 190 of a second bike 100 via the communication interfaces of the control devices 190. In a fleet or caravan of bikes 100, the control device 190 of a lead bike 100 can transmit signals to the control devices 190 of other bikes 100 within the caravan. For example, users in a fleet of bikes 100 can operate the user input device 800, or some other device (e.g., an operator’s mobile device, some other network-connected device), to select a lead bike 100 from which the bikes 100 will receive control signals. In this way, the control device 190 of the lead bike 100 can cause, for example, the first PCBA 315 of the lead bike 100 to activate the first light element 310, and can transmit a control signal to the control devices 190 of the other bikes 100 within the fleet such that the control devices 190 of the other bikes 100 cause the first PCBA 315 to activate the first light element 310 of each of the other bikes 100.

Each of the control device 190, the first control PCBA 320, the first PCBA 315, and the second PCBA 335 can include one or more processors coupled with one or more memory devices. For example, the memory devices can store instructions that, when executed by the one or more processors can cause the one or more processors to perform operations. The operations can include, for example, operating the first light element 310, the second light element 330, or some other light element (e.g., the light ring 235). For example, the first PCBA 315 can cause the first light element 310 to operate in response to a signal, where the signal can be provided to the first PCBA 315 via the first control PCBA 320, where the first control PCBA 320 can receive the signal from the control device 190 via the communication interface or via some other means. For example, the first PCBA 315 can receive a wired or wireless signal via the communication interface and, in response to the received signal, cause the first light element 310 to operate. The received signal can be, for example, an input from an operator (e.g., a user, an owner of the bike 100, or some other authorized individual). The input from the operator can be input provided via a mobile application on a mobile device (e.g., cellular phone, tablet computer, or other device), an NFC tap between a key card or mobile device and the some portion of the bike 100 (e.g., the user input device 800 as depicted in FIG. 8, among others), or some other input. The operator input can be a physical (e.g., tactile) input provided via a button, switch, or otherwise. The operator input can cause the first PCBA 315 to operate the first light element 310 emit light, for example.

The front light assembly 125 includes the light ring 235 positioned around the first projector 225 in the second projector 230. For example, the light ring 235 can be LED strip positioned around at least a portion of an internal perimeter of the cavity 220 of the front light assembly 125. The light ring 235 can include at least one element configured to emit light. In some examples, the light ring 235 can emit light through the lens cover 240 of the front light assembly 125 without also emitting through some other lens (e.g., lens 300 of the first projector 225). The light ring 235 can be or include at least one LED that can, in response to an electrical or control signal, emit light of some intensity, temperature, or wavelength, for example. The light ring 235 can emit light of varying colors, according to some examples. For example, the light ring 235 can include at least one RGB LED that can emit colored lights in response to some electrical or control signal. The light ring 235 can be electrically and communicatively coupled with the second PCBA 335 such that both the light ring 235 and the second projector 230 can be controlled or operated via the second PCBA 335. The light ring 235 can include multiple light rings such as an inner light ring, and an outer light ring, where the inner light ring and the outer light ring can perform various different illuminating functions. For example, the light ring 235 can include an inner light ring that is positioned approximate to the first projector 225 in the second projector 230, where the inner light ring can include multiple RGB LEDs to illuminate various colors. The light ring 235 can include the outer light ring having a single color LED, such as an amber LED, to illuminate an amber light and perform a turn signal function, for example. It is understood, however, that the light ring 235 generally, as well as the inner light ring and outer light ring specifically, can perform various functions or operate in various modes according to one or more signals received by the control device 190, the first control PCBA 320, or the second PCBA 335, according to a user’s preference.

The bike 100 can include the front light assembly 125, and thus the first projector 225, the second projector 230, and the light ring 235, integrated with the bike 100. Specifically, the front light assembly 125 can be rigidly coupled to the frame 120 and integrated with the frame 120, rather than being a separate accessory or aftermarket component. For example, the front light assembly 125 includes the back surface 245 at an angle that corresponds with an angle of the head tube 180 of the bike 100 where the first projector 225 and the second projector 230 can be substantially configured to admit a horizontal direction with the front light assembly 125 coupled with the head tube 180 of the bike 100. In addition, the front light assembly 125 is communicably and electrically integrated with the bike 100. As noted above, the front light assembly 125 can be electrically and communicably coupled with the control device 190 of the bike 100, such as via the harness 205. In this way, the operation of the front light assembly 125 can be controlled via the control device 190. For example, as discussed below with reference to FIG. 8, among others, bike 100 can include user input device 800 that can receive various inputs from a user. Such inputs can cause the control device 190 to provide a signal to the front light assembly 125 to control the front light assembly 125. Similarly, the control device 190 of a bike 100 can receive control signals from other bikes, or a lead bike, in a fleet or caravan of bikes to control the front light assembly 125. In this way, the front light assembly 125 can be controlled by various control devices or user input devices that are or are not integral to the bike 100, rather than being controlled by some external control associated exclusively with the front light assembly 125.

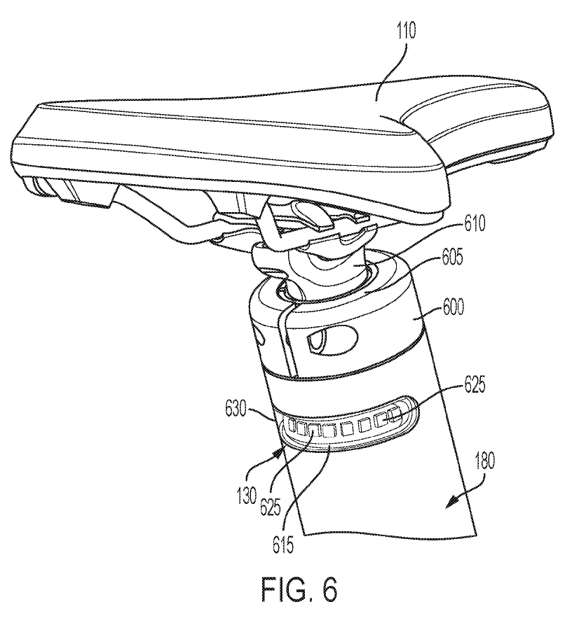

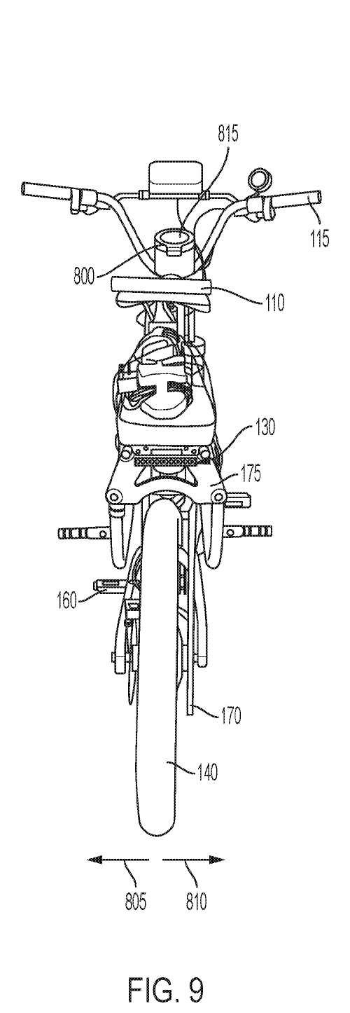

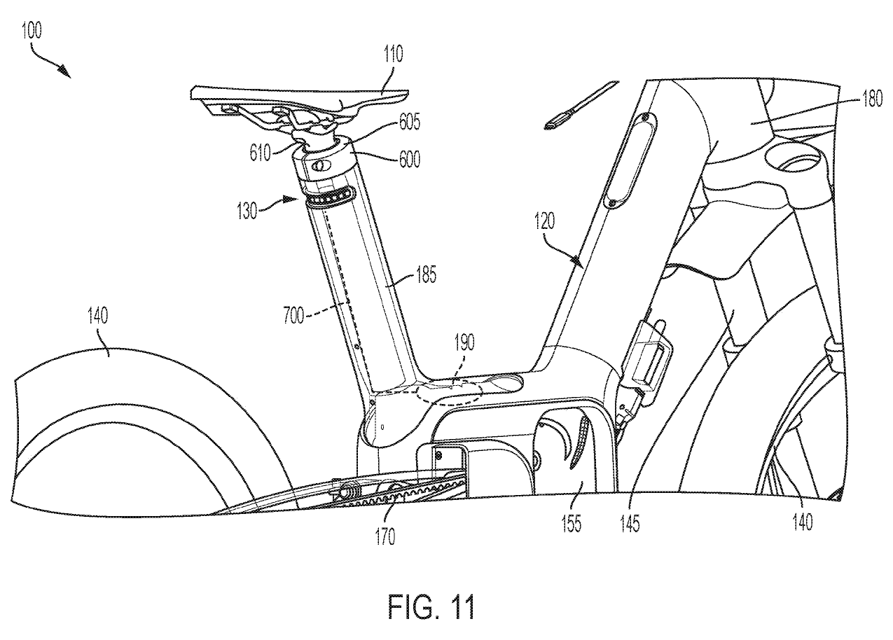

As depicted in FIGS. 6–13, among others, the bike 100 can include the rear light assembly 130. The rear light assembly 130 can include at least one light element 625, at least one housing 615, at least one lens cover 630, and can be communicably and electrically coupled with the control device 190 via at least one harness 700. In some embodiments, the rear light assembly 130 can include a control device 190, shown as a second control PCBA 620 (e.g., positioned within the housing 615) to control operation of the light element 625 of the rear light assembly 130. For example, the second control PCBA 620 can be similar in structure and function to the first control PCBA 320 discussed above, that is coupled with the rear light assembly 130 and positioned at least partially within the housing 615 of the rear light assembly 130. In other examples, the rear light assembly 130 may not include its own control device, and instead, is controlled by the control device 190 of the bike 100. For example, the harness 700 can communicably and electrically couple the rear light assembly 130 with the control device 190 such that the control device 190 can control the rear light assembly 130. The light element 625 of the rear light assembly 130 can emit light in response to electrical or control signal of a varying intensity, temperature, or wavelength. For example, the first light element 310 can be or include an RGB LED that can selectively emit light of various colors in response to a signal. In some examples, the light element 625 can be or include an array of multiple LEDs, each of which can be controlled individually or in concert with other LEDs of the light element 625.

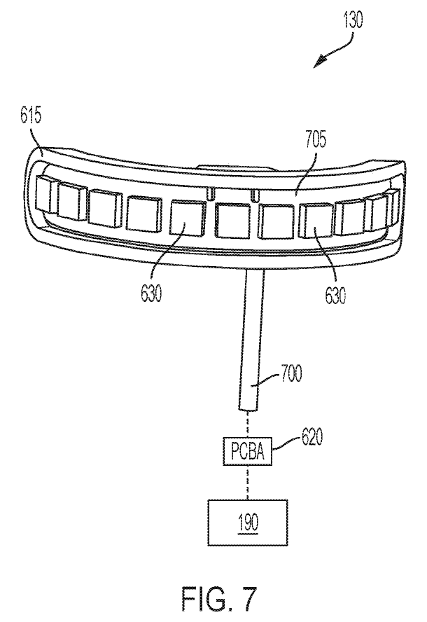

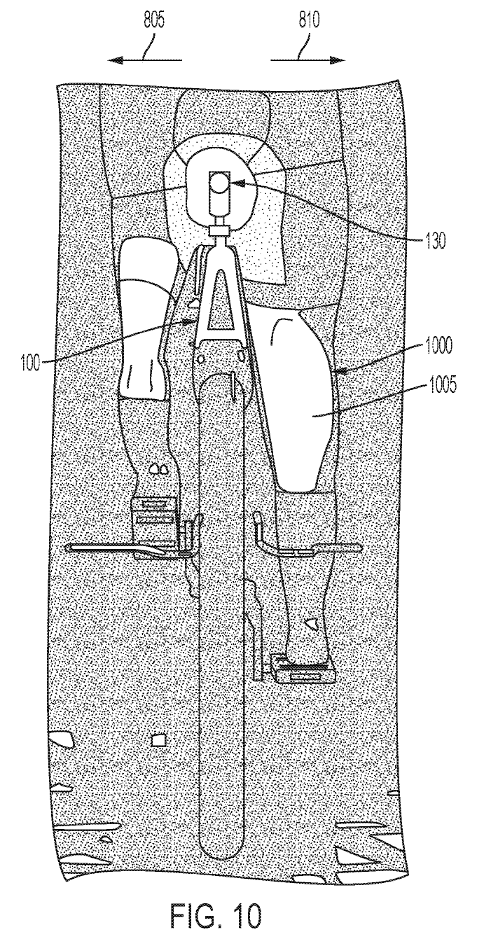

The rear light assembly 130 can be coupled with the top tube 185 of the bike 100. For example, the rear light assembly 130 can be coupled with the top tube 185 and positioned proximate a top portion 605 of the top tube 185, where the top tube 185 can define an opening that can receive a stem or post 610 of the saddle 110. The bike 100 can include a retaining mechanism 600 that can retain the post 610 of the saddle 110 within the opening of the top tube 185. In such examples, the rear light assembly 130 is facing rearward and is generally positioned underneath the saddle 110 of the bike 100. Because the rear light assembly 130 is coupled with the top tube of the bike 100, the rear light assembly 130 can include a curvature, a form factor, or a profile that corresponds to a curvature, a form factor, or a profile of the top tube 185. In this way, the rear light assembly 130 can be discreetly positioned on the top tube 185 and underneath the saddle 110 in a manner that is integral with the bike 100. Moreover, because the top tube 185 includes a curved shape in the example depicted in FIG. 7, among others, the rear light assembly 130 can wrap at least partially around a circumference of the top tube 185 so that at least a portion of the rear light assembly 130 is configured to emit light to a first side 805 or a second side 810 of the bike 100, rather than only emitting light in a rearward direction. For example, the rear light assembly 130 can include an illumination coverage 820 that emits light to the first side 805 or the second side 810 of the top tube 185 of the bike 100 as the user is operating the bike 100. The first side 805 and the second side 810 can be opposing sides of the top tube 185 of the bike 100. The illumination coverage 820 may have an beam angle 825 of approximately 40°–120°, 60°–100°, 80°–90°, or >90°. For example, the rear light assembly 130 can light to one or both of the first side or the second side and in an at least partially downward direction, such that the light emitted by the rear light assembly 130 can illuminate a portion of a limb 1005 of a user, as shown in FIG. 10, among others. Advantageously, the illumination coverage 820 of the rear light assembly 130 capturing and illuminating a portion of a limb 1005 of the user can indicate the presence of the user riding the bike 100 to other bystanders or other riders more clearly than if the rear light assembly 130 only emitted light in a rear direction. In this way, the rear light assembly 130 can illuminate human movement (e.g., biomotion) as depicted in FIG. 10, among others, where such illuminated human movement is more readily identifiable by bystanders or other riders than merely the existence of a light independent of any suggestion of human movement.

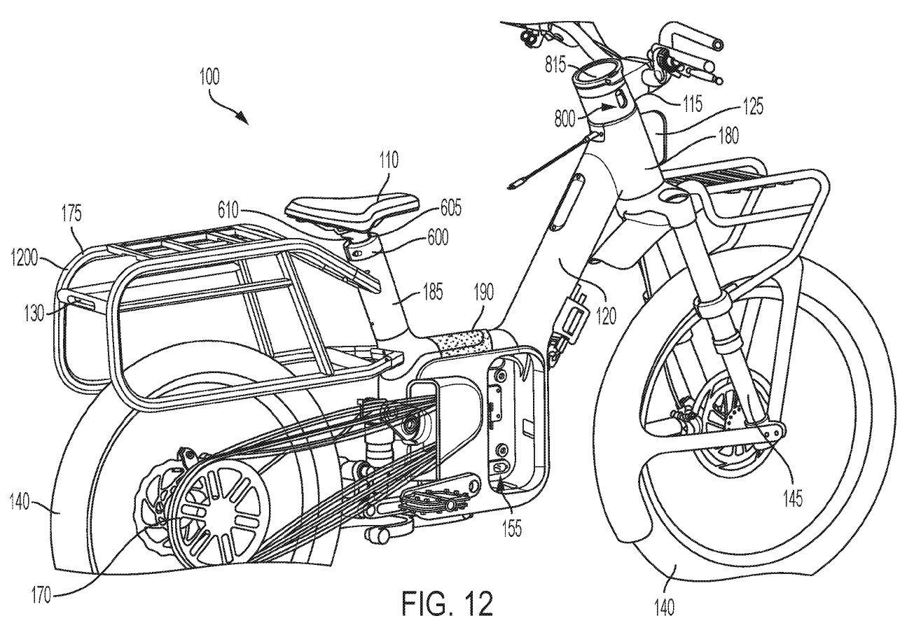

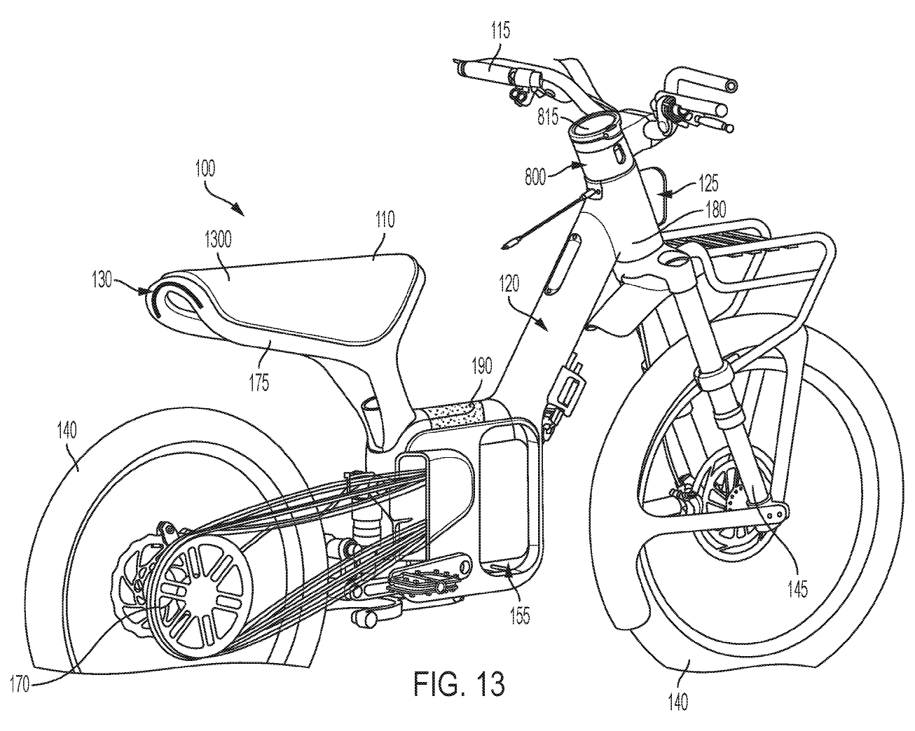

As noted above, the bike 100 can include various rear members 175. For example, in addition to or instead of the saddle 110 the bike 100 can include a rack 1200, as depicted in FIG. 12, among others. In other examples, the bike can't include an elongated saddle 1300 that extends rearward over the rear wheel 140, as depicted in FIG. 13, among others. In various embodiments, the rear member 175 can extend rearward of the top tube 185 in a manner that can at least partially obscure the top tube 185 at least partially from view. Accordingly, the rear light assembly 130 can be positioned on a rear portion 165 or some other portion of the rear member 175 so as to ensure visibility of the rear light assembly 130 from the rear of the bike 100. It is understood that various other rear assemblies can be used, such as child seats, pet carriers, baskets, platforms for large objects, or other rear assemblies. In various examples, the rear light assembly 130 of the bike 100 can be integral with any such rear assembly of the bike 100.

The rear light assembly 130 can be integral with the bike 100. For example, the rear light assembly 130 can be structurally, electrically, and communicably integral with the bike 100. The rear light assembly 130 can be rigidly coupled to the frame 120 and integrated with the frame 120, rather than being a separate accessory or aftermarket component. For example, the rear light assembly 130 can be integrated with the top tube 185 or the rear member 175 of the bike 100, rather than merely being fastened to or detachably coupled on the top tube 185 or the rear member 175. In addition, the rear light assembly 130 is communicably and electrically integrated with the bike 100. As noted above, the rear light assembly 130 can be electrically and communicably coupled with the control device 190 of the bike 100, such as via the harness 700. In this way, and operation of the rear light assembly 130 can be controlled via the control device 190. For example, the bike 100 can include the user input device 800 that can receive various inputs from a user. Such inputs can cause the control device 190 to provide a signal to the rear light assembly 130 to control the rear light assembly 130. Similarly, the control device 190 of a bike 100 can receive control signals from other bikes, or a lead bike 100, in a fleet or caravan of bikes to control the rear light assembly 130. In this way, the rear light assembly 130 can be controlled by various control devices or user input devices that are integral or are not to the bike 100, rather than being controlled by some external control associated exclusively with the rear light assembly 130.

The rear member 175 of the bike 100 can be selectively removed from the frame 120 of the bike 100 so that the rear member 175 of the bike 100 can change to suit a particular case or a user preference. The rear light assembly 130 can be integrated into the rear member 175 or the top tube 185 such that removal of the rear member 175 or the top tube 185 from the frame 120 of the bike 100 also removes the rear light assembly 130 from the bike 100. Removal of the rear light assembly 130 from the bike 100 can sever an electrical or communicable connection between the control device 190 and the rear light assembly 130. However, coupling of the top tube 185 or the rear member 175 with the frame 120 of the bike 100 can electrically and communicatively couple the rear light assembly 130 with the control device 190. The electrical and communicable connection between the rear light assembly and the control device 190 is established when the top tube 185 or the rear member 175 is coupled with the frame 120 of the bike 100. In such an arrangement, the rear light assembly 130 can communicate with the control device 190 simply by virtue of installation of the top tube 185 or the rear member 175 with the bike frame 120.

As depicted in FIG. 8, among others, the bike 100 can include at least one user input device 800. The user input device 800 can include at least one display 815 and at least one communication interface, processor, and memory. The user input device 800 can allow a user of the bike 100 to control or operate the bike 100 and various components of the bike 100. For example, the user input device 800 can allow the user to operate the bike 100 to ride the bike 100, park the bike 100, secure the bike 100, or otherwise operate the bike 100. The user input device 800 can allow the user to operate, directly or indirectly, the front light assembly 125 the rear light assembly 130, or some other light assembly on the bike 100 during operation of the bike 100. For example, the user can independently control one or more of the front light assembly 125, the rear light assembly 130, or some other light assembly on the bike 100 using the display 815 of the user input device 800. The user input device 800 can be electrically and communicably coupled to the control device 190. User input received via user input device (e.g., via the display 815 of the user input device 800) can be provided to the control device 190, which can further control the front light assembly 125, the rear light assembly 130, or some other light assembly of the bike 100. For example, a user input can directly control the front light assembly 125, the rear light assembly 130, or some other light assembly on the bike 100. Direct control implies that the user is selecting at least one specific parameter for operation of the front light assembly 125, the rear light assembly 130, or some other light assembly of the bike 100. For example, the user may select a color and intensity, or some other characteristic for the light ring 235 of the front light assembly 125. As another example, a user can select user-selectable elements associated with predefined operations of the front light assembly 125, the rear light assembly 130, or some other light assembly of the bike 100. For example, a user can operate the user input device 800, or some other input device, to activate a turn signal. The control device 190 can receive a turn signal command based on the user’s input to activate the turn signal. The control device 190 can, upon receipt of the turn signal command, operate the front light assembly 125, the rear light assembly 130, or some other light assembly of the bike 100 according to a predefined turn signal characteristic (e.g., causing light elements of the front light assembly 125, the rear light assembly 130, or some other light assembly of the bike 100 to emit light based on their position relative to a side of the bike, in accordance with a predefined sequence, or in accordance with a predefined pattern, among other possible turn signal indicators). It is understood that the rear light assembly 130 or any other light assembly of the bike 100 that is integrated with the bike 100 can further be controlled directly by the user via the user input device 800.

In other examples, the control device 190 can control one or more of the front light assembly 125, the rear light assembly 130, or some other light assembly of the bike 100 without any direct input from the user. For example, the control device 190 can control one or more of the front light assembly 125, the rear light assembly 130, or some other light assembly of the bike 100 based on a mode of operation of the bike 100 or some action taken by operation of the bike 100. In one example, the control device 190 can cause one or both of the front light assembly 125 and the rear light assembly 130 to operate as the user is riding the bike 100. The control device 190 can cause a specific operation of the front light assembly 125, such as operation of a day running light using one or more of the first projector 225 and the second projector 230, operation of the first projector 225 to illuminate according to European regulations during a nighttime operation of the bike 100, of the second projector 230 according to US regulations during a nighttime operation of the bike 100, or an operation of the projector or the second projector 230 to create a high beam function during a nighttime operation of the bike 100, operation of one or more of the first projector 225, the second projector 230, or the light ring 235 illuminate, according to a fog light function, to operation of at least a portion of the light ring 235 according to a turn, signal function, or various other functions of the front light assembly 125.

In another example, the control device 190 can cause one or both of the front light assembly 125 and the rear light assembly 130 to operate in a particular manner as the user approaches the bike 100 to begin riding the bike 100 or as the user departs the bike 100 after completing a ride of the bike 100. For example, the control device 190 can detect the presence of the user or a mobile device of the user within proximity of the control device 190 and thus within proximity of the bike 100, and can, based on this detected presence, cause the front light assembly 125 or the rear light assembly 130 to illuminate according to a predefined pattern or animation. The control device 190 can cause one or more of the front light assembly 125 and the rear light assembly 130 to illuminate in a particular fashion (e.g., in some sequence or with some color) to indicate a state of charge of the battery 105 of the bike 100, to indicate the progress or status of a charging operation of the battery 105 of the bike 100, or to indicate an operational state of the battery 105 or a battery charger configured to charge the battery 105. The control device 190 can cause one or both of the front light assembly 125 and the rear light assembly 130 to illuminate in a particular fashion to indicate some other state of the bike 100, such as a need for maintenance, the status of an over the air software update, or some other state of the bike 100. The control device 190 can cause one or both of the front light assembly 125 and the rear light assembly 130 to illuminate in a particular fashion to provide some other notification to the user or bystanders, such as a notification corresponding to some other notification received on the user’s mobile device, which can be communicatively coupled with the control device 190 of the bike via the communication interface of the control device 190, or the communication interface of some other device (e.g., the user input device 800, the first control PCBA 320, the first PCBA 315, or the second PCBA 335).

In an example where a bike 100 is a part of a fleet or caravan of bikes 100 riding together, the control device 190 can cause one or both of the front light assembly 125 and the rear light assembly 130 to operate in a particular manner based on user inputs via the user input device 800, or some other input device (e.g., mobile phone), received by the control device 190 of a lead bike. For example, if a user of the lead bike 100 operates the user input device 800, or some other input device, to activate a turn signal, then the control device 190 of the lead bike can cause one or both of the front light assembly 125 and the rear light assembly 130 to operate as a turn signal (e.g., activating lights of at least one of the front light assembly 125 or the rear light assembly 130 aligned with the first side 805 or the second side 810, depending on which turn direction is indicated by the user input, causing lights on the first side 805 or the second side 810 to flash, or activate in sequence, among other possible manners of operation). Additionally, the control device 190 of the lead bike can transmit a control signal to the control devices 190 of the other bikes 100 within the caravan, such that the control devices of the other bikes cause one or both of the front light assembly 125 and the rear light assembly 130 to operate as a turn signal. If a user of the lead bike 100 activates the brakes of the bike 100, the control device 190 of the lead bike 100 can cause one or both of the front light assembly 125 and the rear light assembly 130 to operate in a particular manner associated with braking (e.g., emitting a solid light in a predefined color, or emitting a flashing light, among other possible manners of operation). Additionally, the control device 190 of the lead bike can transmit a control signal to the control devices 190 of the other bikes 100 within the caravan, such that the control devices of the other bikes cause one or both of the front light assembly 125 and the rear light assembly 130 to operate in the particular manner associated with braking. In this way, the other bikes 100 within the caravan or fleet may emit a brake light prior to the users of the other bikes 100 activating the brakes of the other bikes 100.

The control device 190 may receive an anticipated route of travel for the bike 100. For example, a user can input via the user input device 800, or via another device, such as a mobile device, a navigational route, or a desired location and an origin point, among other route information. The anticipated route of travel for the bike 100 can be or include a path between two or more points. The control device 190 can receive lookahead information associated with the anticipated route (e.g., from a user, from a third party data provider). Lookahead information can refer to upcoming conditions that may be experienced or encountered by the bike 100 while traveling on the route. For example, lookahead information can be or include road grade information, route curvature information, elevation information, or street names, among other lookahead information. Based on the anticipated route data, the lookahead information, or a combination thereof, the control device 190 can cause one or both of the front light assembly 125 and the rear light assembly 130 to operate in a particular manner. For example, if the bike 100 is within a predefined threshold distance of an upcoming turn on the anticipated route, the control device 190 can cause one or both of the front light assembly 125 and the rear light assembly 130 to operate as turn signals.

Each light element of a given light assembly, such as the front light assembly 125, the rear light assembly 130, or another light assembly integrated with the bike 100, can be individually operable in multiple states. For example, the control device 190 can cause the front light assembly 125, the rear light assembly 130, or another light assembly integrated with the bike 100 to operate in a state of a plurality of operational states, such as ON, OFF, flashing, or sequential activation, pulsing, fading, or color-shifting. Each light element within the front light assembly 125, the rear light assembly 130, or another light assembly integrated with the bike 100, can emit light at variable intensities, including full intensity or partial intensity (e.g., 50%, 25%). Each light element can emit light in one or more selectable colors, which can be achieved through multi-color light-emitting diodes (LEDs), phosphor-converted LEDs, laser sources, or other suitable light-generating technologies. The control device 190 can coordinate the states of multiple light elements within a single light assembly, such as the first projector 225, the second projector 230, or the light ring 235 of the front light assembly 125, one or more light elements 625 of the rear light assembly 130, or another light assembly to create illumination patterns. The control device 190 can coordinate the states of multiple light elements within multiple light assemblies, such as the first projector 225, the second projector 230, or the light ring 235 of the front light assembly 125, and one or more light elements 625 of the rear light assembly 130, to create illumination patterns. For example, the control device 190 can cause at least one light element of the front light assembly 125 and at least one light element of the rear light assembly 130 to blink in unison as a turn signal.

FIG. 14 is a block diagram illustrating an architecture for a computing system 1400 that can be employed to implement elements of the systems and methods described and illustrated herein, including, for example, the bike 100, among others. For example, the control device 190, the first control PCBA 320, the first PCBA 315, the second PCBA 335, and the user input device 800 can be or include the computing system 1400 can include at least one bus 1405 or other communication component for communicating information and at least one processor 1410 or processing circuit coupled to the bus 1405 for processing information. The computing system 1400 can also include one or more processors 1410 or processing circuits coupled to the bus for processing information. The computing system 1400 also includes at least one main memory 1415, such as a random access memory (RAM) or other dynamic storage device, coupled to the bus 1405 for storing information, and instructions to be executed by the processor 1410. The main memory 1415 can be used for storing information during execution of instructions by the processor 1410. The computing system 1400 may further include at least one read-only memory (ROM) 1420 or other static storage device coupled to the bus 1405 for storing static information and instructions for the processor 1410. A storage device 1425, such as a solid-state device, magnetic disk, or optical disk, can be coupled to the bus 1405 to persistently store information and instructions. The computing system 1400 can include a communication interface 1440.

The communication interface 1440 may include any combination of wired and/or wireless interfaces (e.g., jacks, antennas, transmitters, receivers, transceivers, wire terminals) for conducting data communications with various systems, devices, or networks structured to enable in-micromobility device communications (e.g., between and among the components of the bike 100) and/or out-of-micromobility device communications (e.g., with a remote server, with a control device 190 of another bike 100, with a mobile device). For example, and regarding out-of-micromobility device communications, the communication interface 1440 can include an Ethernet card and port for sending and receiving data via an Ethernet-based communications network, and/or a Wi-Fi transceiver for communicating via a wireless communications network. The communication interface 1440 may be structured to communicate via local area networks or wide area networks (e.g., the Internet) and can use a variety of communications protocols (e.g., IP, LON, Bluetooth, ZigBee, radio, cellular, near field communication).

The computing system 1400 may be coupled via the communication interface 1440 to a display 1435, such as a liquid crystal display, or active matrix display, for displaying information to a user such as a rider of the bike 100 or other end user. An input device 1430, such as a keyboard or voice interface may be coupled to the bus 1405 via the communication interface 1440 for communicating information and commands to the processor 1410. The input device 1430 can include a touch screen display 1435. The input device 1430 can also include a cursor control, such as a mouse, a trackball, or cursor direction keys, for communicating direction information and command selections to the processor 1410 and for controlling cursor movement on the display 1435.

The processes, systems, and methods described herein can be implemented by the computing system 1400 in response to the processor 1410 executing an arrangement of instructions contained in main memory 1415. Such instructions can be read into main memory 1415 from another computer-readable medium, such as the storage device 1425. Execution of the arrangement of instructions contained in main memory 1415 causes the computing system 1400 to perform the illustrative processes described herein. One or more processors in a multi-processing arrangement may also be employed to execute the instructions contained in main memory 1415. Hard-wired circuitry can be used in place of or in combination with software instructions together with the systems and methods described herein. Systems and methods described herein are not limited to any specific combination of hardware circuitry and software.

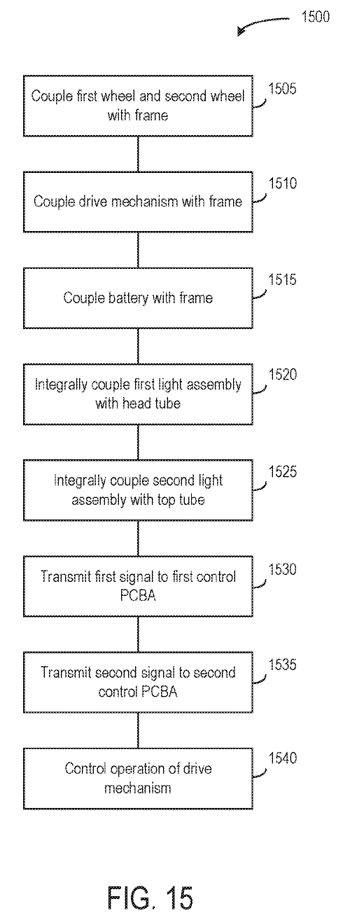

FIG. 15 is a flow diagram of an example method 1500 of assembling and operating the bike 100. The method 1500 can include at least one act of coupling the first wheel 140 and the second wheel 140 with the frame 120 (e.g., act 1505). For example, the first wheel 140 and the second wheel 140 can be rotatably coupled with the frame 120. The frame 120 can be coupled with the first wheel 140 and the second wheel 140 such that a portion of the frame 120 (e.g., the handlebar 115 or a steering member, among others) can steer at least one of the first wheel 140 or the second wheel 140.

The method 1500 can include at least one act of coupling the drive mechanism 155 with the frame 120 (e.g., act 1510). The drive mechanism 155 can be an electrical motor or some other electrical propulsion mechanism that can create some motion (e.g., rotation of some shaft) in response to an electrical signal. The drive mechanism 155 can be coupled with, for example, the middle portion 150 of the frame 120. The drive mechanism 155 can be coupled with the frame 120 directly or indirectly. For example, a housing of the drive mechanism 155 can couple with the frame 120 via one or more fasteners, or other coupling elements. The drive mechanism 155 can be integrally coupled with the frame 120 such that it is not removable. The drive mechanism 155 can be detachably coupled with the frame 120 such that the drive mechanism 155 or a component thereof can be removed (e.g., to service the drive mechanism 155). The method 1500 can include at least one act of coupling the battery 105 with the frame 120. The battery 105 can be installed on the frame 120 of the bike 100 within one or more of the front portion 135, the middle portion 150, or the rear portion 165. The battery 105 can be integrally coupled with the frame 120 such that it is not removable. The battery 105 can be detachably coupled with the frame 120 such that it can be removed (e.g., to charge the battery 105).

The method 1500 can include at least one act of integrally coupling the front light assembly 125 with the frame 120. For example, the front light assembly 125 can be integrally coupled with the front portion 135 of the frame 120 (e.g., act 1520). The front light assembly 125 can, for example, be integrally formed with the head tube 180 of the frame 120. In this way, at least a portion of the front light assembly 125 can be non-removable from the frame 120. Some portions of the front light assembly 125, such as the first projector 225, the second projector 230, the light ring 235, or light-emitting elements therein can be removable from the frame 120 (e.g., for replacement). The method 1500 can include at least one act of integrally coupling the rear light assembly 130 with the frame 120 (e.g., act 1525). For example, the rear light assembly 130 can be integrally coupled with the top tube 185 of the frame 120. In this way, at least a portion of the rear light assembly 130 can be non-removable from the frame 120. Some portions of the rear light assembly 130, such as the light element 625, can be removable from the frame 120 (e.g., for replacement).

The method 1500 can include at least one act of transmitting, by the control device 190, a first control signal to a first control PCBA 320 (e.g., act 1530). The first control PCBA 320 can be positioned within the front light assembly 125. The first control PCBA 320 can transmit signals to the front light assembly 125, or to another PCBA (e.g., the first PCBA 315, the second PCBA 335), to cause the front light assembly 125 to emit light. For example, the first control PCBA 320 can be electrically and communicably coupled with the first PCBA 315 and the second PCBA 335. The first control PCBA 320 can receive power from the battery 105, whether directly from the battery 105 or indirectly such as via the control device 190, and provide electrical energy to the first PCBA 315 and the second PCBA 335, each of which can respectively provide power to the first light element 310 and the second light element 330. For example, the battery 105 can provide power to the first control PCBA 320, the first control PCBA 320 can provide power to the first PCBA 315, and the first PCBA 315 can in turn provide power to the first light element 310. Likewise, the battery 105 can provide power to the first control PCBA 320, the first control PCBA 320 can provide power to the second PCBA 335, and the second PCBA 335 can in turn provide power to the second light element 330. The first PCBA 315 or the first control PCBA 320 can control or modulate a polarity of a voltage provided to the first light element 310 to influence the operation of the first light element 310. The second PCBA 335 or the first control PCBA 320 can control or modulate a polarity of a voltage provided to the second light element 330 to influence the operation of the second light element 330.

The method 1500 can include at least one act of transmitting, by the control device 190, a second signal to a second control PCBA 620 (e.g., act 1535). The second control PCBA 620 can be positioned within the rear light assembly 130. The second control PCBA 620 can transmit signals to the rear light assembly 130 to cause the rear light assembly 130 to emit light. The second control PCBA 620 can receive power from the battery 105, whether directly from the battery 105 or indirectly such as via the control device 190, and provide electrical energy to the light elements 625. The second control PCBA 620 can control or modulate a polarity of a voltage provided to the light elements 625 to influence the operation of the rear light assembly 130.

The method 1500 can include at least one act of controlling, by the control device 190, the drive mechanism 155 (e.g., act 1540). The drive mechanism 155 can be an electrical motor or some other electrical propulsion mechanism that can create some motion (e.g., rotation of some shaft) in response to an electrical signal. For example, the control device 190 can change, initiate, or cease the drive mechanism 155 by transmitting electrical signals to the drive mechanism 155.

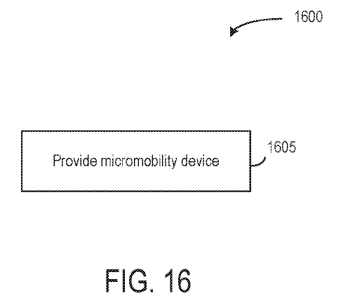

FIG. 16 is a flow diagram of an example method 1600 of providing the micromobility device 100. The method 1600 can include at least one act of providing a micromobility device 100 (e.g., act 1605). For example, providing the micromobility device 100 can include providing (e.g., assembling or manufacturing, in whole or in part) a micromobility device including a frame 120, a head tube 180, and a top tube 185. Providing the micromobility device can include providing a first wheel 140 and a second wheel 140 to be rotatably coupled with the frame 120. Providing the micromobility device 100 can include providing a drive mechanism 155 coupled with the frame 120 and configured to rotate at least one of the first wheel 140 and the second wheel 140. Providing the micromobility device 100 can include providing a battery 105 detachably coupled with the frame 120 and operatively coupled with the drive mechanism 155. Providing the micromobility device 100 can include providing a front light assembly 125 integrally coupled with the head tube 180 and including a first control PCBA 320. Providing the micromobility device 100 can include providing a rear light assembly 130 integrally coupled with the top tube 185 and including a second control PCBA 620. Providing the micromobility device 100 can include providing a control device 190 configured to couple with the frame 120.

In various embodiments, the micromobility device 100 may be designed to support a gross vehicle weight, defined as the combined mass of the device, rider, payload, and accessories, which corresponds to applicable regulatory or industry standards for micromobility devices. By way of example and without limitation, certain bicycle-based and electric bicycle standards, such as ISO 4210 and EN 15194, contemplate testing and design assumptions for a total mass on the order of approximately 120 kilograms, inclusive of rider and load, while other micromobility categories, including scooters, mopeds, and cargo-oriented devices, may be designed for higher gross vehicle weights, such as greater than 120 kilograms, greater than 150 kilograms, or greater than 200 kilograms, depending on jurisdiction, classification, and intended use. In some embodiments, the micromobility device 100 may be configured to comply with regulations and testing protocols, such as those administered by the U.S. Consumer Product Safety Commission, which may specify structural strength, braking performance, and fatigue testing criteria corresponding to representative rider and payload masses. References to such weight values are intended to reflect regulatory examples rather than to impose fixed design limits on the disclosed embodiments.

The propulsion system may include an electric motor, a human-powered drivetrain, or a combination thereof, and may be configured in hub-based, mid-mounted, or remote arrangements using chain, belt, shaft, gear, friction, or direct-drive mechanisms to transmit torque to at least one ground-engaging element. An energy storage system may be provided to store electrical energy for powering the propulsion system and auxiliary components, and may include one or more batteries, capacitors, fuel cells, or other energy storage technologies that may be removable, fixed, swappable, or distributed across multiple locations on the device. The energy storage system may further include charging circuitry, battery management systems, thermal management components, and monitoring elements configured to meet or exceed applicable electrical standards for micromobility devices, including but not limited to UL 2849, UL 2272, IEC 62133, or equivalent regional or international standards.

The micromobility device 100 may further include a control system comprising one or more processors, controllers, sensors, and communication interfaces configured to manage propulsion output, braking behavior, energy usage, and auxiliary functions. The control system may regulate motor output based on rider input, operating conditions, load, speed, inclination, or environmental sensing, and may support software-based features such as diagnostics, data logging, fleet management integration, geofencing, or over-the-air software updates. Braking systems may include mechanical, hydraulic, electromagnetic, regenerative, or combined braking mechanisms, and the device may further include stability features such as traction control, anti-lock braking, suspension systems, steering dampening elements, lighting systems, and audible warning devices. In various embodiments, the micromobility device 100 may be designed to comply with applicable operational and mechanical standards, including but not limited to ISO 4210, EN 15194, SAE J3194, applicable portions of 16 CFR Part 1512, and corresponding regional, national, or municipal micromobility regulations governing speed, power output, braking performance, lighting, and gross vehicle weight classifications.

The micromobility device 100 may include a rider interface configured to receive user input through handlebars, grips, pedals, throttles, buttons, touch interfaces, or gesture-based controls, and may alternatively or additionally include a payload interface configured to support cargo, delivery containers, child seats, or autonomous payload modules. In some embodiments, the micromobility device 100 may be configured as, or convertible between, multiple micromobility form factors, including electric bicycles, scooters, mopeds, seated or standing ride-on devices, or cargo and utility vehicles, wherein such configurations may share common components or differ only in selected structural, propulsion, control, or interface elements. Unless otherwise stated, the components and features described herein may be combined, omitted, rearranged, scaled, or substituted without departing from the scope of the disclosure, and references to regulatory standards or weight limits are intended to be exemplary and non-limiting.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer-readable storage medium, and modules can be distributed across various hardware or computer-based components.

The systems described above can provide multiple ones of any or each of those components and these components can be provided on either a standalone system or on multiple instantiations in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component,” or “data processing apparatus” or the like encompass various apparatuses, devices, and machines for processing data, including, by way of example, a programmable processor, a computer, a system on a chip, or multiple ones, or combinations of the foregoing. The apparatus can include special-purpose logic circuitry, e.g., an FPGA (field-programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup-language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special-purpose logic circuitry, e.g., an FPGA (field programmable gate array) or an ASIC (application specific integrated circuit). Devices suitable for storing computer program instructions and data can include non-volatile memory, media, and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special-purpose logic circuitry.

The subject matter described herein can be implemented in a computing system that includes a back end component, e.g., a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, and although many of the examples presented herein involve specific combinations of method acts or system elements, those acts and those elements may be combined in other ways to accomplish the same objectives. Acts, elements, and features discussed in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation or embodiment, and references to “an implementation,” “some implementations,” “one implementation,” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

Where technical features in the drawings, detailed description, or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes, and proportions of the various elements, values of parameters, mounting arrangements, use of materials, colors, and orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes, and omissions can also be made in the design, operating conditions, and arrangement of the disclosed elements and operations without departing from the scope of the present disclosure.

Further relative parallel, perpendicular, vertical, or other positioning or orientation descriptions include variations within +/-10% or +/-10 degrees of pure vertical, parallel, or perpendicular positioning. References to “approximately,” “substantially,” or other terms of degree include variations of +/-10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A micromobility device, comprising:
a frame including a head tube and a top tube;
a first wheel and a second wheel rotatably coupled with the frame;
a drive mechanism coupled with the frame and configured to rotate at least one of the first wheel and the second wheel;
a battery coupled with the frame and operatively coupled with the drive mechanism, the battery configured to cause the drive mechanism to rotate the at least one of the first wheel and the second wheel;
a front light assembly integrally coupled with the head tube and including a first control printed circuit board assembly (PCBA);
a rear light assembly integrally coupled with the top tube and including a second control PCBA; and
a control device coupled with the frame and configured to:
transmit a first signal to the first control PCBA to cause the front light assembly to emit light at a first state of a first plurality of states in which the front light assembly emits light;
transmit a second signal to the second control PCBA to cause the rear light assembly to emit light at a second state of a second plurality of states in which the rear light assembly emits light; and
control an operation of the drive mechanism.

2. The micromobility device of claim 1, comprising:
the front light assembly includes a cavity, a first projector, a second projector, and a light ring, the first projector, the second projector, and the light ring positioned within the cavity of the front light assembly, the first projector and the second projector positioned within a perimeter of the light ring.

3. The micromobility device of claim 1, comprising:
the front light assembly includes a cavity, a first projector, and a second projector, the first projector and the second projector positioned within the cavity of the front light assembly,
wherein the first state includes the first projector or the second projector emitting light without the other of the first projector or the second projector emitting light.

4. The micromobility device of claim 1, comprising:
the front light assembly including a cavity, a first projector, a second projector, and a light ring, the first projector, the second projector, and the light ring positioned within a cavity of the front light assembly, the first projector and the second projector positioned within a perimeter of the light ring;
wherein the first state includes at least one of the first projector, the second projector, or the light ring emitting a first intensity, and
the control device is configured to:
transmit a third signal to the first control PCBA to cause the front light assembly to emit light at a second state of the first plurality of states, the second state of the first plurality of states including at least one of the first projector, the second projector, or the light ring emitting a second intensity different from the first intensity.

5. The micromobility device of claim 1, wherein the micromobility device is a first micromobility device and the control device of the first micromobility device is configured to receive control signals from a second control device of a second micromobility device,
wherein the control signals from the second control device indicate a state of a front light assembly of the second micromobility device and a state of a rear light assembly of second micromobility device, and the control device of the first micromobility device is configured to:
transmit a third signal to the first control PCBA to cause the front light assembly of the first micromobility device to have a same state as the state of the front light assembly of the second micromobility device; and
transmit a fourth signal to the second control PCBA to cause the rear light assembly of the first micromobility device to have a same state as the state of the rear light assembly of the second micromobility device.

6. The micromobility device of claim 1, comprising:
the rear light assembly including a plurality of light elements, the rear light assembly having a curvature corresponding to a curvature of the top tube,
wherein the second state includes operating the plurality of light elements of the rear light assembly to emit light at least partially to a first side and to a second side of the top tube to illuminate a limb of a user during operation of the micromobility device, wherein the first side and the second side are opposing sides of the top tube.

7. The micromobility device of claim 1, wherein the control device is configured to:
receive data indicative of a state of charge of the battery; and
transmit a third signal to at least one of the first control PCBA or the second control PCBA to cause at least one of the front light assembly or the rear light assembly to emit light based on the state of charge of the battery.

8. The micromobility device of claim 1, wherein the control device is configured to:
receive data indicative of a proximity of a user to the micromobility device; and
transmit a third signal to at least one of the first control PCBA or the second control PCBA to cause at least one of the front light assembly or the rear light assembly to emit light based on the user of the micromobility device being within a predefined proximity of the micromobility device.

9. The micromobility device of claim 1, wherein the control device is configured to:
receive data indicative of a state of charge of the battery; and
transmit a third signal to at least one of the first control PCBA or the second control PCBA to cause at least one of the front light assembly or the rear light assembly to emit light based on a status of a charging operation of the battery.

10. The micromobility device of claim 1, comprising:
a user input device coupled with the frame, the user input device including a display configured to receive a user input; and
wherein the control device is configured to transmit a third signal to at least one of the first control PCBA or the second control PCBA to cause at least one of the front light assembly to emit light at the first state or the rear light assembly to emit light at the second state based on the user input.

11. The micromobility device of claim 1, comprising:
the rear light assembly including a plurality of light elements extending between a first side of the micromobility device and a second side of the micromobility device,
wherein the first state includes a portion of the front light assembly aligned with the first side of the micromobility device emitting light based on receipt of a first turn signal command, and
the second state includes a first portion of the plurality of light elements aligned with the first side of the micromobility device to emit light based on receipt of the first turn signal command.

12. The micromobility device of claim 1, comprising:
a user input device coupled with the frame, the user input device including a display configured to receive a first turn signal command via a user input;
the front light assembly including a cavity, a first projector, a second projector, and a light ring, the first projector, the second projector, and the light ring positioned within a cavity of the front light assembly, the first projector and the second projector positioned within a perimeter of the light ring; and
the rear light assembly including a plurality of light elements extending between a first side of the micromobility device and a second side of the micromobility device,
wherein the control device is configured to:
transmit the first signal to the first control PCBA to cause the front light assembly to emit light at the first state based on receipt of the first turn signal command, the first state including a first portion of the light ring aligned with the first side of the micromobility device emitting light; and
transmit the second signal to the second control PCBA to cause the rear light assembly to emit light at the second state based on receipt of the first turn signal command, the second state including a first portion of the plurality of light elements of the rear light assembly aligned with the first side of the micromobility device emitting light.

13. The micromobility device of claim 1, comprising:
the front light assembly including:
the first control PCBA configured to receive signals, including the first signal, from the control device and to transmit control signals,
a first light element,
a first PCBA coupled with the first control PCBA and with the first light element, the first PCBA configured to cause the first light element to emit light based on receipt of a first control signal from the first control PCBA,
a second light element, and
a second PCBA coupled with the first control PCBA and with the second light element, the second PCBA configured to cause the second light element to emit light based on receipt of a second control signal from the first control PCBA.

14. A bike, comprising:
a frame including a head tube and a top tube;
a first wheel and a second wheel rotatably coupled with the frame;
a drive mechanism coupled with the frame and configured to rotate at least one of the first wheel and the second wheel;
a control device coupled with the frame and configured to receive and to transmit control signals;
a front light assembly integrally coupled with the head tube, the front light assembly including a first printed circuit board assembly (PCBA), a first light element, a second light element, and a third light element, the PCBA communicably coupled with the control device, the PCBA configured to receive a signal from the control device to:
cause the first light element to emit light at a first state of a plurality of different states;
cause the second light element to emit light at a second state of a plurality of different states; and
control the third light element to emit light at a third state of a plurality of different states, wherein each of the first state, the second state, and the third state are different; and
a rear light assembly integrally coupled with the top tube, the rear light assembly including a plurality of light elements communicably coupled with the control device, the control device configured to:
cause at least one of the plurality of light elements to emit light at a fourth state of the plurality of different states.

15. The bike of claim 14, comprising:
the front light assembly including a cavity,
the first light element including a first projector positioned within the cavity,
the second light element including second projector positioned within the cavity, and
the third light element including a light ring positioned within the cavity, wherein the first projector and the second projector positioned within a perimeter of the light ring.

16. The bike of claim 14, comprising:
the front light assembly including a cavity,
the first light element including a first projector positioned within the cavity, and
the second light element including a second projector, the first projector and the second projector positioned within the cavity of the front light assembly,
wherein the first state includes the first projector emitting light having a first characteristic, the second state includes the second projector not emitting light, and the third state includes the third light assembly emitting light having a second characteristic different from the first characteristic.

17. The bike of claim 14, comprising:
the rear light assembly including a curvature corresponding to a curvature of the top tube such that the plurality of light elements of the rear light assembly extend around at least a portion of a circumference of the top tube;
wherein the fourth state includes the plurality of lights of the rear light assembly emitting light at least partially to a first side and a second side of the bike to illuminate a limb of a user during operation of the bike.

18. The bike of claim 14, comprising:
a user input device coupled with the frame, the user input device including a display configured to receive a first turn signal command via a user input;
the rear light assembly including a curvature corresponding to a curvature of the top tube such that the plurality of light elements of the rear light assembly extend around at least a portion of a circumference of the top tube;
wherein the fourth state includes causing a first portion of the plurality of light elements aligned with a first side of the bike to emit light based on receipt of the first turn signal command.

19. The bike of claim 14, comprising:
the front light assembly including:
the first control PCBA configured to receive signals, including the first signal, from the control device and to transmit control signals,
a first PCBA coupled with the first control PCBA and with the first light element, the first PCBA configured to cause the first light element to emit light based on receipt of a first control signal from the first control PCBA, and
a second PCBA coupled with the first control PCBA and with the second light element, the second PCBA configured to cause the second light element to emit light based on receipt of a second control signal from the first control PCBA.

20. A method, comprising:
rotatably coupling a first wheel of a bike and a second wheel of the bike with a frame of the bike, the frame including a control device, a head tube, and a top tube;
coupling a drive mechanism with the frame to rotate at least one of the first wheel and the second wheel;
coupling a battery with the frame, the battery operatively coupled with the drive mechanism and configured to cause the drive mechanism to rotate the at least one of the first wheel and the second wheel;
integrally coupling a front light assembly including a first control PCBA with the head tube;
integrally coupling a rear light assembly including a second PCBA with the top tube;
transmitting, by the control device, a first signal to the first control PCBA to cause the front light assembly to emit light at a first state of a first plurality of states in which the front light assembly emits light;
transmitting, by the control device, a second signal to the second control PCBA to cause the rear light assembly to emit light at a second state of a second plurality of states in which the rear light assembly emits light; and
controlling, by the control device, an operation of the drive mechanism.
